(19) United States
(12) Patent Application Publication
(10) Pub. No.: US 2007/0248733 A1
(43) Pub. Date: Oct. 25, 2007

(54) READY MEAL FOR PETS

(76) Inventor: Pietro Gaggiotti, Parma (IT)

Correspondence Address: LATHROP & GAGE LC, 2345 GRAND AVENUE, SUITE 2800, KANSAS CITY, MO, 64108, US

(21) Appl. No.: 11/770,605

(22) Filed: Jun. 28, 2007

(30) Foreign Application Priority Data
Apr. 7, 2006 (IT) BO2006A 000515

(51) Int. Cl. A23L 1/16

(52) U.S. Cl. 426/557

(57) ABSTRACT

A pet food product and method is disclosed. Embodiments of the invention include meals for pets which are ready to eat, and include the ingredients of some sort of food normally consumed by humans. The product is preserved in stabilized packaging so that the ingredients will not spoil, and the pet is able to eat the food without it being heated up or otherwise prepared. In some embodiments, the product is a pasta dish for dogs. The ingredients are, in embodiments, all natural and also specially adapted for the health and palate of the pet according to veterinary principles.

### CROSS-REFERENCE TO RELATED APPLICATIONS

This application claims the benefit of Italian Patent Application No. BO2006A 000515, filed Jul. 4, 2006 the disclosure of which is incorporated herein.

### BACKGROUND OF THE INVENTION

The invention relates generally to the field of providing food for consumption by pets. More specifically, the invention relates to the field of providing ready-to-eat meals including human natured ingredients which tend to humanize the pet.

### SUMMARY

The present invention is defined by the claims below. Embodiments of the present invention, however, include a method comprising: selecting a human food relating to a particular genre; modifying at least one ingredient of said human food such that a modified version of ingredients will result in a product which is beneficial to a pet; processing the modified version of ingredients to result in the product, the processing including preserving said modified version of ingredients in a container; and then marketing the product in the container as said human food which has been adapted for pet consumption.

### BRIEF DESCRIPTION OF THE DRAWINGS

FIG. 1 shows a flow diagram including the processes for one embodiment.

### DETAILED DESCRIPTION

Embodiments of the invention include meals for pets which are ready to eat, and are of the nature of some sort of food normally adapted for human consumption. Embodiments also include the pet food product in stabilized packaging so that the ingredients will not spoil, and the pet is able to eat the food without it being heated up or otherwise prepared. The product, in embodiments, is a real human food which has been adapted for the health of the pet when consumed. For example, in some embodiments, the product is a pasta dish for dogs. In order to meet the specific needs of the animal, however, the pasta is overcooked by human standards. This makes the pasta softer, and easier to chew, and more easily digested by the pet. In another aspect, embodiments of the pasta dishes, salt and other things bad for the pet have been reduced in the recipe, or eliminated completely from the list of ingredients.

Despite these deviations from the human versions, however, the ready-to-eat pasta dishes disclosed herein still look like human pasta dishes, and are comprised of human-quality ingredients.

In some embodiments, the product is all natural in that it does not include any artificial colors or preservatives. This further contributes to the health of the consuming animal.

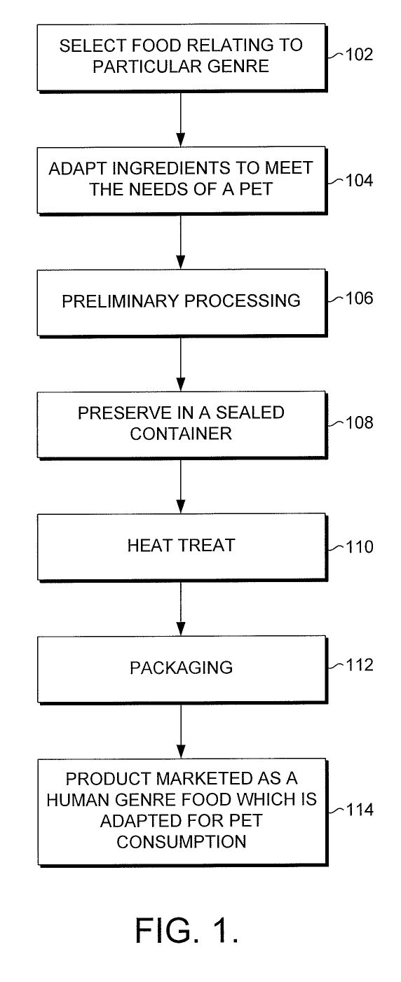

The preparation process is common to all of the pasta examples which are to follow. A flow diagram showing an embodiment 100 for the process is shown in FIG. 1. Referring to the figure, in a first step 102, the process begins with selecting a particular food relating to a human food genre. The food will typically include a plurality of ingredients (e.g., pasta, sauce, meat). In the embodiments discussed below, this genre is Italian food. In alternative embodiments, however, the genre might be Chinese, Mexican, Continental, French, Japanese, or some other international or other specialty cuisine.

In a next step 104, these ingredients will be selected and combined into a recipe which is specifically adapted to meet the needs of the pet. For example, modifications are made to the ingredients which make the product more acceptable to the pet's palate. Additionally, the product is modified such that it is more beneficial to the pet's health. In the disclosed embodiments, this step has been executed in accord with veterinary principles. As discussed already, the ingredients, in embodiments, are all natural, and nutritious from a veterinary perspective. Iodized salt, and salty foods, although globally popular and arguably harmless for humans are incompatible with the palates and overall health of some pets, e.g., dogs. For example, aside from dehydration, salt can cause stomach ailments and pancreatitis. Further, some breeds of dogs have been known, after consuming too much salt, to gulp large amounts of water within a short time creating a life threatening situation. Thus, in the embodiments disclosed below, salt, an ingredient normally included in the recipes of pasta dishes as well as other foods for humans is either minimized or completely eliminated from the particular recipe. This does not necessarily involve complete elimination or any elaborate removal process (although such is contemplated in these disclosures). For example, in most instances, insubstantial amounts of salt are included in commercially available pasta products. It is recognized that in most cases it might be practical to leave this salt in the product. But in the embodiments disclosed above, e.g., the salt removed is simply the salt that would have normally been added as an ingredient in the recipe. Thus, simply a reduction or elimination of salt as a separate added ingredient. Other examples of ingredients commonly included in human food which should be avoided in adapting step 104 because they are potentially harmful to dogs are alcohol, avocado, onion and onion powder, caffeine, chocolate or any other ingredient including theobromine which is a pet-adverse stimulant and diuretic, citrus oil extracts, grapes, raisins, mushrooms, celery, macadamia nuts or butter, and numerous other ingredients which, although acceptable for human consumption, are not healthy for pets.

In Italian food embodiments, the included ingredients in terms of percentages could include (i) a percentage of pasta which is between 5% and 95% of the total weight of the product; (ii) a percentage of rice which is between 5% and 95% of the total weight of the product; (iii) a percentage of bran flour which is between 5% and 95% of the total weight of the product; (iv) a percentage of maize flour which is between 5% and 95% of the total weight of the product; (v) a percentage of beef between 5% and 95% of the total weight of the product; (v) a percentage of chicken between 5% and 95% of the total weight of the product; (vi) a percentage of game meat between 5% and 95% of the total weight of the product; (vii) a percentage of fish between 5% and 95% of the total weight of the product; (viii) a percentage of vegetables between 5% and 95% of the total weight of the product; (ix) a percentage of legumes between 5% and 95% of the total weight of the product; (x) a percentage of sea flours or vegetable flours which is between 5% and 95% of the total weight of the product; (xi) a percentage of fish flour which is between 5% and 95% of the total weight of the product.

More specific embodiments of the product showing listings for the all-natural ingredients used are disclosed below:

TABLE I
EXAMPLE PRODUCTS
Example 1: Lasagna With Wild Boar Meat

| | |
|---|---|
| 22% | Vegetable (Tomato and Carrot) |
| 18% | Egg Pasta |
| 8% | Meat (Pork and Ham) |
| 3% | Grain Flour |
| 3% | Oils |
| 3% | Cheese |
| 0.3% | Natural Flavors |
| 45.7% | Water |

Example 2: Fusilli Pasta With Salmon

| | |
|---|---|
| 18% | Pasta |
| 6% | Fish (Salmon) |
| 20% | Vegetable (Tomato and Carrot) |
| 2% | Oil |
| 2.5% | Grain Flour |
| 7% | Cream |
| 44.3% | Water |

Example 3: Rigatoni Pasta With Grouper

| | |
|---|---|
| 18% | Pasta |
| 5% | Fish (Salmon) |
| 20% | Vegetable (Tomato and Carrot) |
| 2% | Oil |
| 3% | Grain Flour |
| 5% | Cream |
| 2% | Cheese |
| 1% | Milk |
| 0.3% | Natural Flavors |
| 43.7% | Water |

Example 4: Cannelloni Pasta With Venison Meat

| | |
|---|---|
| 7% | Meat (Cow and/or Deer) |
| 22% | Vegetable (Tomato and Carrot) |
| 15% | Pasta with Egg Whites |
| 5% | Bread Crumbs |
| 2% | Oil |
| 3% | Cheese |
| 0.3% | Natural Flavors |
| 45.7% | Water |

Example 5: Cheese Tortelloni Pasta With Walnuts

| | |
|---|---|
| 20% | Vegetable with Egg Whites |
| 7% | Cheese |
| 1% | Ham |
| 5% | Bread Crumbs |
| 3% | Grain Flour |
| 4% | Cream |
| 2% | Oil |
| 1% | Anacardi |
| 2% | Butter |
| 1% | Nuts (Walnuts) |
| 0.5% | Garlic |
| 0.5% | Natural Flavors |
| 50% | Water |

Example 6: Ravioli

| | |
|---|---|
| 20% | Vegetable |
| 19% | Pasta with Egg Whites |
| 2% | Meat (Cow and/or Hare) |
| 3% | Bread |
| 6% | Cheese |
| 2% | Grain Flour |
| 2% | Oil |
| 3% | Butter |
| 0.3% | Natural Flavors |
| 42.7% | Water |

Although the examples above all relate to the adaptation of Italian dishes, other embodiments could be directed to other food genres such as Chinese food, Mexican food, inter alia. Further, although the above are all adapted to be more suitable to the palate and health of dogs, it should be understood that the recipes could easily be adapted to the more high-fat requirements for cats, or to similarly meet the particular needs of other animals. Thus, the embodiments shown above should be considered only as exemplary, and not in any limiting sense.

Next, in a step 106, some ingredients may need to be preliminarily processed in a way which is consistent with the end product meeting the needs of the pet. In some embodiments, e.g., for the Fusilli and Rigatoni embodiments above, the pasta is initially in hard dried form, but will be cooked through a heat treatment process which will be described in more detail later. In other embodiments, e.g., the Cannelloni, Lasagna, Tortelloni, and Ravioli embodiments, the pasta is produced in wet, limp form and then put into the container to be cooked further during heat treatment later. Thus, the pasta, in embodiments, is caused to be in wet limp form before introduction into the container.

Other ingredients, e.g., tomato sauces, cheeses, are introduced without cooking, but will be adequately sanitized by heat treatment as described hereinafter. Alternatively, and according to other known processing methods, the pasta and/or other ingredients could be fully cooked prior to their introduction into the containment vessel.

Also in step 106, the ingredients are portioned into quantities. In one embodiment the food is divided into single-serving/single dose portions before being included in the container. In other embodiments, partial or multiple doses are included. This may be done manually, or in other embodiments, executed using known processing techniques.

In a next step 108, a stabilized-packaging process is used in which the container is a plastic tub sized to accommodate the desired portion. This plastic tub (tray) includes a food receiving area and an upper rim. The rim is used to hermetically seal the food product in the food receiving area using a plastic or other kind of membrane which is sealed to the rim in an air tight manner. In one embodiment, a thermally stable plastic is used which will be able to endure a thermal-stabilizing process as discussed hereinafter. These kinds of plastics are readily commercially available. An example of a container material which may be used is polyethylene terephthalate (PET). Film constructed of this same material could also be used to serve as the membrane discussed above. Regardless, some sort of thermally stable material may be used so that the container is able to endure elevated temperatures.

In one embodiment, the ingredients are introduced into the thermally stable container (e.g., tray/tub) while still at slightly elevated temperatures (e.g., about 50° C.) and then the heat-stable membrane is hermetically sealed over the contents onto the rim of the container. Stabilized packaging techniques are known in the art. For example, slightly different processes have been used in the preparation of Meals-Ready-to-Eat (MREs) commonly used to maintain food for military or camping purposes.

The use of the terms “preserved” and “preserving” herein are intended only to mean that some containment and storage technique is used to accomplish placing the product in a state in which it is one of (i) resistant to spoilage, (ii) caused to be free from disease-causing organisms, or both. The use of this term is not to be interpreted as imparting or necessarily including any particular containment means, heat treatment, or processing method unless otherwise specified in the claims.

Again, in one embodiment, a stabilized packaging process is used. But one skilled in the art will recognize that numerous alternative processes could be used instead to accomplish the same objectives. For example, in other embodiments some form of aseptically sealed container could be used. Alternatively, e.g., the containment process could include hot-filling precooked ingredients into an airtight container, which might be some sort of sealed tub or tray, but might also be some kind of flexible pouch. Canning processes could also be used. Still further, the acidity of a precooked food product could be manipulated to have an antimicrobial effect. For example, causing overall PH levels to fall below about 4.5 can kill undesirable microorganisms. This can be done in combination with heat or other treatments. Further, the product could be preserved by freezing, refrigeration, freeze-drying, or other numerous processes. Thus, the potential embodiments are not necessarily limited to any processing method.

The table below shows an example of a product which might be produced according to one embodiment of the processes disclosed. In this embodiment, like many other possibilities, the food products will be laid into the tub in some sort of layering process. Here, the layering will result in the sandwiching of various other ingredients between layers of pasta to create a lasagna product. This example also shows that different sizes are possible.

TABLE II
Lasangna Product Made by Spreading Layers in Plastic Tub:

| | | 230 g | 450 g |
|---|---|---|---|
| N^{o} | | Weight | Weight |
| Layers | Ingredients | (g) +/− 8% | (g) +/− 8% |
| 1 | Tomato | 64 | 93 |
| 2 | Sheet of dry egg pasta | 11 | 11 |
| 3 | Wild boar sauce | 74 | 81 |
| 4 | Sheet of dry egg pasta | 11 | 11 |
| 5 | Wild boar sauce | 70 | 81 |
| 6 | Sheet of dry egg pasta | / | 11 |
| 7 | Wild boar sauce | / | 81 |
| 8 | Sheet of dry egg pasta | / | 11 |
| 9 | Wild boar sauce | / | 70 |

Other embodiments might similarly involve some special arrangment of the food product. For example, production of the Cannelloni of Example 4 above would require a tube-stuffing step, and the Ravioli of Example 6 would require some kind of process to include the cheese inside the pasta.

Once the product is properly included in its preserving container and sealed, the product, in one embodiment, is heat treated in a step 110. As already discussd briefly above, the ultimate pasta product should be overcooked by human standards. Thus, the execution of heat-treatment step 110 should be adapted to create an end product which would be overcooked by human standards, but makes the pasta more digestible and more easily chewed by the pet. In one embodiment, the container is treated by subjecting it to elevated temperatures and pressures in an autoclave oven. As one skilled in the art will know, autoclaves enable pressure control during heating. Here the pressure will be raised above ambient to raise the boiling point during heat treating step 110. This keeps the product from boiling, which might compromise the seal. In the preferred embodiment, the packaged product is subjected to temperatures of about 136 degrees Celsius (about 277 degrees Fahrenheit) for about 22 minutes. This should ensure proper sanitization as well as overcook (slightly) the pasta. Those skilled in the art will recognize, however, that other temperatures and times could be used to accomplish the same objectives. It is also possible that the heat-delivery could be accomplished using microwaves or a microwave oven instead of the more traditional oven. Further, one skilled in the art will recognize that hot water submersion, steam exposure, or some other heat sanitizing systems could be used instead of an oven to create the elevated temperatures necessary. Further, the temperature and heat time could also be altered so long as future spoilage and microbial concerns are mitigated.

Once the product is included and appropriately treated in its stabilized packaging, it will have a shelf life of approximately 18 months when maintained at room temperature and will require no refrigeration until opened. This is advantageous in the marketing of the product because pet stores tend to have no interest in marketing perishable pet foods. To do so would require expensive refrigeration and/or other equipment, is labor intensive, and requires rapid product turnover in terms of sales. These requirements are all undesirable to pet product retailers.

In a step 112, the container is packaged. In one embodiment of this packaging step, the food container (e.g., tub, tray, or pouch) is included along with a plastic knife. In the embodiments where a tray or tub is used, the plastic knife can be included on top of the sealing membrane so that the combined product is meal ready to eat. The plastic tray/tub can serve as a dish/bowl for the pet to use to consume the food. The plastic knife is useful in penetrating the plastic sealing membrane (or alternatively pouch) so that the food can be consumed from the tray. The knife is also useful in stirring the food, if necessary. Thus, the tray and knife enable the user to present the food to the pet for consumption without the use of any other utensils, dishes, or other items which might otherwise have to be cleaned. And after the meal, the entire product can be discarded making for easy cleanup. All of this is contemplated in providing these implements.

In other embodiments of step 112, the hermetically sealed tub/tray and knife are all compactly included in an outer packaging, on which the product is identified as a human food adapted for pet consumption. The packaging might be a box, a polypropylene flow pack wrapper, or some other known kind of packaging. In terms of compactness, the knife is able to be included on top of the plastic sealing membrane. Thus, the outer packaging is then wrapped completely around the dish (which now includes the knife) and sold. In embodiments where the food is contained in a pouch, that pouch can be sized such that it fits within a tray, and the pouch and knife included in the tray, and then packaged for sale. One skilled in the art will recognize that numerous other embodiments for creating a functional packaging are possible.

In other embodiments of step 112, the container itself and/or the plastic sealing membrane can be used to display the indicia discussed above, as well as other information. Thus, the packaging step should in no way be considered critical to the invention, and is not to be considered limiting unless specifically claimed.

In a next step 114, the packaged product is marketed as a human genre food which has been adapted for pet consumption. For example, in some embodiments, the packaging includes indicia and some instructional information. Some indicia is presented which conveys to consumers that the product is a human-type food dish which has been specially adapted for pets. For example, where the product is one of the above, the indicia on the packaging might read “Pasta For Dogs” or “Doggie Pasta.” So that it is clear that the product is a human-like food adapted for consumption by dogs.

Because the product has a shelf life of about 18 months, stores are able to keep it on their shelves for extended periods of time without refrigeration, freezers, or other food maintenance equipment. Further, because the product is all natural and comprised entirely of human-quality ingredients, the product will be seen as a novel and healthy alternative to the lower quality conventional dog-food products. Further, because the tray/tub and plastic membrane are all thermally-stabilized products, the food can easily be heated up in an oven or microwave should the pet owner wish to serve the meal hot. This is of course only optional considering that the meal is safe and ready to eat at room temperature. And finally, the human cuisine aspect affords the consumer a way of humanizing the pets overall lifestyle.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A method comprising:
selecting a human food relating to a particular genre;
modifying at least one ingredient of said human food such that a modified version of ingredients will result in a product which is beneficial to a pet;
providing said modified version of ingredients to result in said product, said providing step including preserving said modified version of ingredients in a container; and
marketing said product in said container as said human food which has been adapted for pet consumption.

2. The method of claim 1 wherein said genre is a specialty food.

3. The method of claim 1 wherein said preserving involves the use of stabilized packaging and heat treatment.

4. The method of claim 1 wherein one of Italian, Chinese, Mexican, Japanese, international, and French cuisines are selected as said genre.

5. The method of claim 1 wherein said at least one ingredient is an amount of salt, and said modifying step involves reducing said amount of salt.

6. The method of claim 1 comprising:
including pasta in said selecting step, and;
overcooking said pasta in said modifying step.

7. The method of claim 1 comprising:
including pasta, tomato sauce, and a meat as some of said ingredients in said selecting step.

8. The method of claim 1 wherein said marketing step comprises:
including indicia on one of said container or a packaging used with said container, said indicia enabling consumers to recognize that said product is said human food which intended for consumption by pets.

9. The method of claim 1 comprising:
adapting said modified version according to veterinary principles and such that said modified version includes only natural ingredients.

10. The method of claim 1 comprising:
limiting said modified version to only include human-quality ingredients.

11. The method of claim 1 comprising:
executing said method step such that said product is fully cooked, ready to eat, and able to be stored at ambient temperatures without spoiling.

12. A pet food product comprising:
a container including human quality ingredients, said human quality ingredients relating to a particular readily-identifiable food, said food normally considered to be for human consumption; said ingredients being adapted for consumption by a pet, said container being adapted to enclose and preserve said ingredients.

13. The pet food product of claim 12 wherein said container is a heat-stable tub which has an upper rim which receives a heat-stable membrane to seal said ingredients in said container.

14. The pet food product of claim 12 wherein said ingredients include pasta and sauce.

15. The pet food product of claim 12 wherein said ingredients include one of meat and a cheese.

16. The pet food product of claim 12 wherein said container is included in packaging, said packaging including indicia informing consumers that said product is said food normally considered to be for human consumption, but that it has been adapted for consumption by dogs.

17. A pet food product comprising:
a container including human quality ingredients, said human quality ingredients relating to a particular readily-identifiable food, said food normally considered to be for human consumption; said ingredients including at least two of: (i) pasta; (ii) rice; (iii) bran flour (iv) maize flour; (v) beef; (v) chicken; (vi) game meat; (vii) fish; (viii) vegetables; (ix) legumes; (x) sea flours or vegetable flours; (xi) cheese;
and (xi) fish flour.

18. The pet food product of claim 17 wherein said food product is adapted to meet the nutritional needs for the pet.

19. The pet food product of claim 17 wherein said container is adapted to be heat-stable and enclose and preserve said ingredients after a heat treatment.

20. The pet food product of claim 17 wherein a quantity for each of the at least two ingredients is between about 5% and 95% of the total weight of the product.
